(19) United States
(12) Patent Application Publication
(10) Pub. No.: US 2005/0031859 A1
(43) Pub. Date: Feb. 10, 2005

(54) Self seal mailer comprising sticker

(75) Inventors: Scott T. Ginkel, Stillwater, MN (US); Sundar J. Rajan, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/635,868

(22) Filed: Aug. 5, 2003

(51) Int. Cl. B32B 23/02; B32B 15/04

(52) U.S. Cl. 428/343; 428/194

(57) ABSTRACT

The invention discloses self-seal mailer form constructions comprising and methods of making form constructions.

### FIELD OF THE INVENTION

The invention discloses self-seal mailer form construction and methods of making form constructions.

### BACKGROUND OF THE INVENTION

Validation stickers are used as proof of registration of automobiles and other motor vehicles (e.g. trucks, snowmobiles, etc.) These retroreflective stickers generally have a printable plastic top surface and a pressure sensitive adhesive (PSA) on the bottom with a protective liner that is removed before it is adhered to the ultimate surface such as an automobile license plate. Such stickers usually have printed variable information. The end user (e.g. vehicle owner) typically also gets a card with his/her name, address, amount paid, etc., at the time the fees are paid to the issuing agency. Issuing agencies prefer to print these stickers and cards at the same time and on demand as needed. In order to do so, it is common to pre-attach stickers with the liners to cards via an additional layer of adhesive between the liner and the card surface prior to the printing operation.

U.S. Pat. No. 6,092,843 (Abstract) describes a license plate decal provided on a folded (e.g. Z-folded) business form that acts as a carrier for the decal. A cut out is formed in a panel of the mailer and a patch (such as a glassine patch) is adhesively secured at a peripheral portion to the mailer panel and a release coating is provided on at least a significant part of the central portion of the patch. The decal adhesive engages the release coating so that the decal and its associated pressure sensitive adhesive may be readily removed from the patch. The patch may be secured to the paper on either face thereof; if secured at the bottom face, the patch and decal can flex into the cutout to provide a minimum thickness when in a stack of mailer intermediates. Where the patch is secured at its top face, the maximum thickness of the patch and decal combination is preferably about 0.008 inches, which is significantly less than the thickness at the decal in prior art carriers.

U.S. Pat. No. 6,406,787 (Abstract) describes a novel form construction comprising a form sheet having a digital printable surface portion and a release surface portion, on which release coating surface portion a signage with a pressure-sensitive adhesive can be releasably adhered. A digital printable release coating composition is also provided.

### SUMMARY OF THE INVENTION

The invention discloses a (e.g. self-seal) mailer comprising a form substrate such as paper and an adhesive disposed on the form such that the form may be folded and self-sealed. In one aspect, the mailer comprises a digital printable surface portion and a release coating disposed on the form substrate. In another aspect, the mailer comprises a digital printable release coating.

In further aspects, a sticker comprising a backing and a pressure sensitive adhesive is releasably attached to the release coating. The backing of the sticker preferably comprises a polymeric film. In some embodiments, the backing is preferably retroreflective. The sticker is preferably a vehicle registration sticker, validation sticker, parking permit sticker, or a park permit sticker. The sticker may further comprise at least one tamper indicating feature. The form substrate may be a sheet or a roll-good having perforations such that the form can be separated into individual sheets.

In other aspects, the invention discloses methods of making a self-seal mailer. The adhesive employed to self-seal the mailer may be applied prior to or after applying the release coating and/or sticker.

### BRIEF DESCRIPTION OF THE DRAWINGS

FIGS. 1a and 1b depict a plan view of the inside and outside respectively of an exemplary tri-fold self-seal mailer having a sticker.

FIG. 2 is a cross-section of a portion of the self-seal mailer at the location the sticker is releasably bonded (e.g. along line 2 of FIG. 1a).

FIGS. 3a and 3b depict a plan view of the inside and outside respectively of an exemplary bi-fold self-seal mailer having a sticker and a security pattern.

FIGS. 4a and 4b depict a plan view of the inside and outside, respectively of an exemplary Z-fold self-seal mailer having a sticker and a security pattern.

The drawings depicted herein are illustrative of form construction of the present invention and are not necessarily drawn to scale.

### DETAILED DESCRIPTION OF THE PREFERRED EMBODIMENTS

The present invention is directed to self-seal mailer form construction articles and methods of making form constructions.

In one aspect, the mailer comprises a form sheet having a printable surface portion (e.g. to be filled in by a printer), a release coating, and an adhesive disposed on the form such that the form my be folded and self sealed. The printable surface portion and release coating surface portion may be separate areas from each other, or may overlap with each other. In one aspect, the release coating surface portion is provided only where a sticker (e.g. signage) is to be applied and the form is substantially free of release coating on the remainder of the form. In another aspect, the whole surface of one side (e.g. inside) of the form sheet is rendered printable and releasable by providing a printable release coating thereto.

The invention employs a form substrate. The form substrate is preferably paper. However, the form substrate may comprise other porous or non-porous materials such as various films, nonwovens, cardboard and woven fabric. For embodiments wherein the substrate is not sufficiently printable, the substrate may further comprise an ink-receptive coating on at least the printable surface portion.

The form substrate is preferably a square or rectangular shaped paper sheet having top, bottom, and side edges, and first and second faces, the top and bottom edges substantially parallel to each other and the side edges substantially parallel to each other. The form substrate may be provided as an individual sheet or in a roll form. In the case of rolls, individual sheets are typically bordered by lines of weaknesses such as perforations. Bi-fold designs generally have a single fold substantially parallel to the top and bottom edges that divide the sheet into two panels, the panels being approximately equal in dimension. Tri-fold designs generally have at least two fold lines, e.g. a first and second fold lines substantially parallel to the top and bottom edges and dividing the sheet into first, second and third panels, the first panel between the top edge and the first fold line, the second panel between the first and second fold lines, and the third panel between the second fold line and bottom edge.

At least a portion of the form substrate and preferably the entire form substrate is printable. Further, at least a portion of the sticker is preferably printable as well. “Printable” refers to sufficient anchorage of the printing composition (e.g. toner, ink) such that a graphic formed by the composition is readable. Preferably at least 50% of the printing composition is adhered to the printable surface portion. More preferably at least 70% and most preferably at least 90% of the printing composition is adhered to the printable surface portion. The form and/or sticker may be printed prior to providing the release coating or prior to applying the sticker to the form. Preferably, however, the form is filled-in via printing and the sticker printed simultaneously with the same printing operation.

Although the form and/or the sticker may be printed using screen printing, letter press, offset, laser (i.e. electrophotographic) or thermal transfer printing technologies, the form and/or sticker are preferably digital printable. As used herein, “digital printable” refers to printable by a digital printing method including, laser, inkjet, thermal mass transfer, thermal dye transfer, electrostatic, ion deposition, electron beam imaging, solid ink-Jet and dot-matrix printings. It is most preferred to digital print by means of a laser printing, thermal mass transfer, or ink-jet printing. The printing may employ black and/or colored printing media (e.g. liquid ink, ribbon, toner powder).

The form substrate further comprises an adhesive disposed on the form such that the form may be folded and self sealed. Various bi-fold, tri-fold (e.g. Z-fold) self-seal mailers comprising a pre-applied adhesive are known, such as described in various patents. Such self-seal mailers generally have a water activated, heat activated or pressure activated adhesive along at least a perimeter portion of the form. Additional adhesive may also be provided at the perimeter portion of a fold. In the case of tri-fold designs, adhesive is typically present about the perimeter of a panel on the backside of the form as well. The adhesive is generally provided such that upon folding and sealing, the adhesive is disposed between the interior folds of the sealed mailer. Although the mailer may comprise a pressure sensitive adhesive covered by a release liner, non-tacky adhesives are typically preferred to facilitate automated means of sealing the mailers. Self-seal mailers having a preapplied adhesive are commercially available from various suppliers including Moore Business Forms (Grand Island, N.Y.), Standard Register (Cleveland, Ohio), and Relizon Corp. (Dayton, Ohio). As an alternative to employing a self-seal mailer as the form substrate, an adhesive may be applied to the form substrate at any time.

In contrast to employing a release liner to protect the pressure-sensitive adhesive of the sticker until use, the self-seal mailer comprises a release coating disposed on the form substrate (e.g. paper). “Disposed on the form substrate” refers to the form construction being substantially free of a substrate, (i.e. additional layers, such as films and paper having structural integrity) between the release coating and the form substrate. The lack of such substrate layers reduces the thickness of the form construction at the location of the sticker in order that the form construction along with the sticker may be printed without the form jamming in the printer. Although the form construction is substantially free of a substrate layer between the form substrate and the release coating, the form substrate may comprise one or more coating, such as a primer for example, disposed between the release coating and the form substrate. For some embodiments, the primer reduces the porosity of porous substrates such as paper to insure the subsequently applied release coating is present on the surface of the form substrate. A preferred primer is a (e.g. clear) radiation curable ink such as commercially available from Akzo Nobel Inks, (Akron, Ohio) under the trade designation “Flexocure”. In other embodiments, such as for polymeric based form substrates, the primer may be provided to improve the adhesion of the release coating to the form substrate.

Any suitable release coating that allows pressure-sensitive adhesive release of the sticker may be used for the purpose of the present invention. It is preferred, however, that the release coating is heat and humidity stable since certain printing operations (such as laser printing and thermal transfer printing) involve a heat treatment process. If the release coating is not heat and humidity stable, the adhesive of the sticker (e.g. signage) in contact with the release coating may deteriorate after printing process or upon aging. Adhesion loss is preferably less than 10% and more preferably less than 5% after a heat treatment in printing such as a fusing process of laser printing.

The release coating may be applied only at the location of the sticker. Typically the surface area having the release coating is at least slightly larger than the adhesive surface of the sticker as depicted in the drawings. Coating the form substrate in part in this manner can be accomplished by spot coating. Alternatively, stripe coating may be employed. For embodiments wherein the release coating is applied to a substantially larger surface area of the form substrate, the release coating is digital printable to ensure that the presence thereof does not detract from the printability of the form. If the release coating hinders the self-seal properties of the mailer, it is preferred to avoid coating the locations of the self-seal adhesive. Alternatively, aggressive adhesives may be employed that would not be detrimentally affected by the presence of the release coating. Suitable (e.g. digital printable) release coatings are described in U.S. Pat. No. 6,406,787; incorporated herein by reference.

A sticker (e.g. signage) is releasably attached to the release coating. As used herein, “sticker” refers to a substrate that has a length and width smaller than the form substrate and comprises a pressure sensitive adhesive on at least one face. The pressure sensitive adhesive on the sticker face is suitable for adhering the sticker to its intended target surface such as a vehicle window or license plate. The sticker is typically premanufactured prior to bonding the sticker to the form substrate. During the manufacture of the sticker, prior to bonding the sticker to the form substrate, the PSA of the sticker is typically transfer coated to the sticker substrate by means of a release liner. The release liner typically comprises a paper or plastic film material having a release coating. The sticker is removed from its release liner employed during the manufacture thereof and releasably adhered to the release coating surface.

The sticker(s) may be provided anywhere on the form, provided that the release coating is present on such portion. The sticker(s) is typically provided in a center portion of a panel such that the peripheral edge area (i.e. within about 3 cm from the edges) of the form is substantially free of the sticker. By providing the sticker(s) on the form construction in this manner, the presence of the sticker(s) does not hinder the folding and sealing of the mailer.

A preferred method of making the form construction entails providing a pre-formed self-seal mailer as the form substrate, applying release coating to the mailer, drying and/or optionally curing the release coating, and releasably attaching the pressure sensitive adhesive of a sticker to the release coating. Alternatively, adhesive suitable for self-sealing the form substrate may be applied to the form after application of the release coating either prior to or after releasably attaching the sticker.

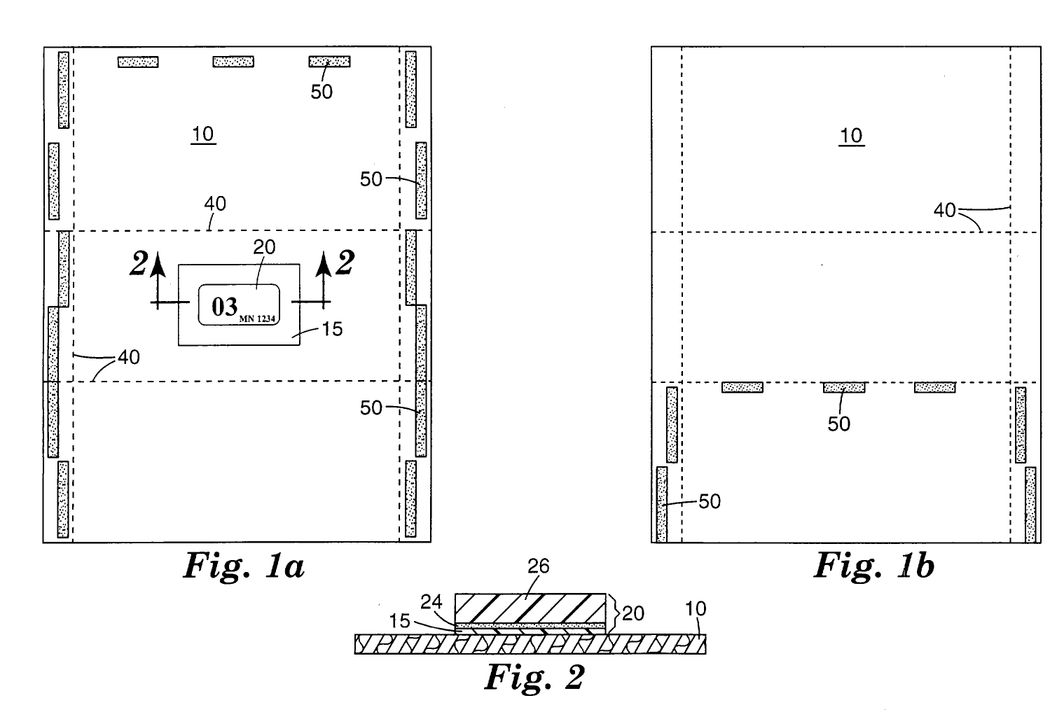

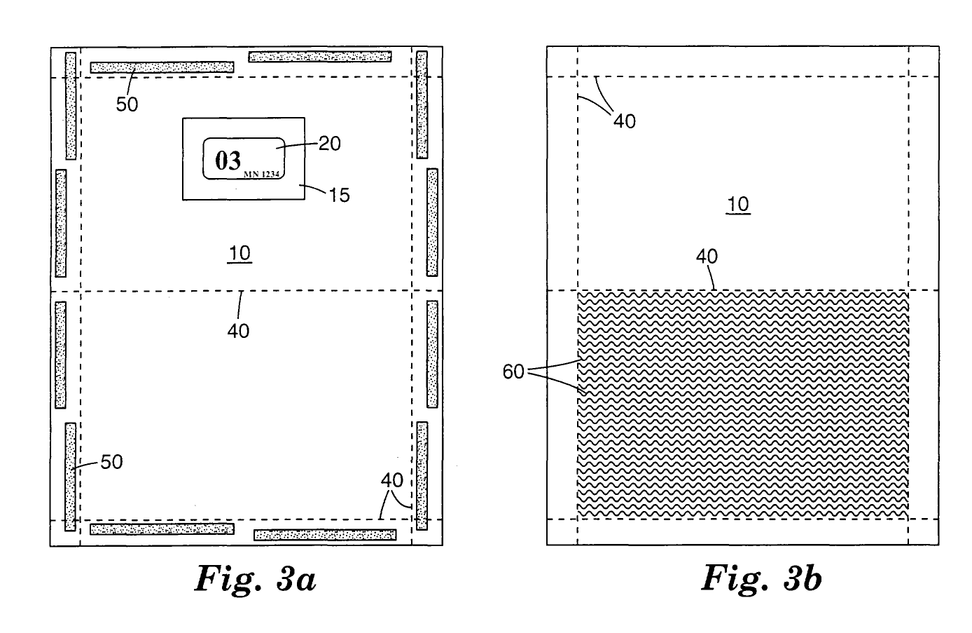

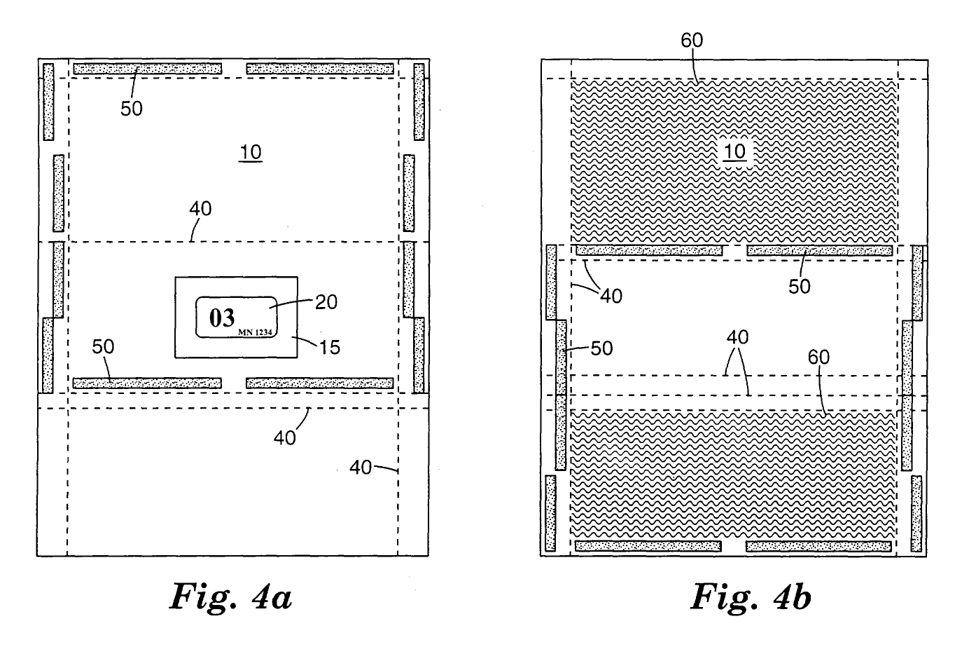

FIGS. 1-4 depict various exemplary form constructions of the invention comprising a form substrate 10 (e.g. paper), a release coating 15 disposed on the form substrate, and an adhesive 50. Adhesive 50 of the form construction is provided such that the form may be folded and self-sealed. Each of these form constructions further comprise sticker 20 releasably adhered to the release coating. As depicted in FIG. 2, sticker 20 comprises a pressure sensitive adhesive 24 that is permanently bonded the sticker substrate 26 (i.e. sticker backing). Self-seal mailers generally comprise lines of weakness 40 such as perforations. Lines of weakness extending through the center portion of the form substrate 10 are typically fold lines; whereas as lines of weakness near the peripheral edges of the form are typically tear lines for opening the sealed mailer. FIGS. 1 and 4 are both tri-fold mailers; whereas as FIG. 3 is a bi-fold mailer. The form construction of FIG. 1 comprises self-seal adhesive 50 along the longitudinal peripheral edge portion, along the peripheral edge portion of the top panel of the form, and on the lower panel of the outside of the mailer at the peripheral edge portion along the fold line as well as on both longitudinal edge portions. The mailer is folded such that the adhesive of the bottom panel contacts the adhesive of the center panel followed by contacting the adhesive of the top panel with the adhesive of the backside of the bottom panel. FIG. 4 is a Z-fold tri-fold mailer wherein the mailer is folded such that the adhesive of the top panel contacts the adhesive of the center panel followed by contacting the adhesive of the backside (i.e. outside) of the bottom panel with the adhesive of the backside of the center panel. The self-seal mailer of FIGS. 3 and 4 also further comprise a security pattern 60 that hinders the ability to view sticker 20 through the panel(s) of the form substrate 10 covering the sticker.

Although the “sticker substrate” 26 (i.e. backing) may comprise materials such as paper, the sticker substrate is preferable durable material. Preferred durable materials include various polymeric films that may be opaque, transparent, translucent, reflective or retroreflective. A pressure-sensitive adhesive 24 is present on a major surface of the sticker. In conventional stickers the pressure sensitive adhesive is disposed on the non-viewing surface or backside of the adhesive. Other sticker constructions, such as those intended to adhere to the inside of a vehicle window for example, alternatively employ a pressure sensitive adhesive on the viewing surface. For this embodiment the intended viewing surface of the sticker would be facing the adhesive 24 and thus would not be viewable when releasably adhered to the form construction.

Although the form construction depicted in each of FIGS. 1-4 comprise a single sticker, the form construction may comprise multiple stickers as well wherein at least one of the stickers is releasably adhered to a release coating disposed on the form substrate. A preferred form construction comprises a validation sticker in combination with a registration sticker, such as described in concurrently filed attorney docket no. FN 58185US003 entitled “Method of Making Printable Forms Comprising Stickers and Articles”.

The pressure sensitive adhesive 24 of the sticker may be derived from a variety of known water-based, solvent-based, radiation curable and 100% solids hot melt adhesive compositions. Preferred adhesive compositions are selected depending on the intended duration of use and expected exposure conditions of the sticker (e.g. temperature, humidity, sunlight). For example, removable adhesive compositions may be used for temporary uses (e.g. single day parking pass). For longer durations of intended use, it is preferred that the adhesive composition is initially repositionable, meaning that the sticker can be removed without damaging the sticker and reapplied, and then subsequently forms a permanent bond with the target surface (e.g. windshield).

Suitable pressure sensitive adhesives (PSAs) for use in the invention for bonding the sticker to the target surface (e.g. license plate) and optionally bonding the sticker to the form substrate are preferably repositionable at least temporarily or may be aggressive such that the sticker cannot be removed without damaging the sticker. In general, PSAs adhere to substrates without the need for more than hand pressure, and require no activation by water, solvent or heat. Suitable PSAs are disclosed, for example, in U.S. Pat. No. 5,725,935 (Signage Articles Methods of Making the Same), which is herein incorporated by reference.

PSAs suitable in the present invention are preferably selected from the group consisting of alkylacrylate polymers and copolymers; copolymers of alkylacrylates with acrylic acid; terpolymers of alkylacrylates, acrylic acid, and vinyl-lactates; alkyl vinyl ether polymers and copolymers; polyisoalkylenes; polyalkyldienes; alkyldiene-styrene copolymers; styrene-isoprene-styrene block copolymers; polydialkylsiloxanes; polyalkylphenylsiloxanes; natural rubbers; synthetic rubbers; chlorinated rubbers; latex crepe; rosin; cumarone resins; alkyd polymers; and polyacrylate esters and mixtures thereof. Examples include polyisobutylenes, polybutadienes, or butadiene-styrene copolymers, and mixtures thereof (such polymers and copolymers preferably have no reactive moieties, i.e., are not oxidized in the presence of air); silicone-based compounds such as polydimethylsiloxane, and polymethylphenylsiloxane combined with other resins and/or oils.

Other suitable PSAs also include tackified thermoplastic resins and tackified thermoplastic elastomers, wherein the tackifier comprises one or more compounds which increases the tack of the composition. An example of a tackified thermoplastic resin useful as an aggressively PSA is the combination of a vinyl acetate/ethylene copolymer known under the trade designation VYNATHENE EY 902-30 (available from Quantum Chemicals, Cincinnati, Ohio) with substantially equal portions of the tackifiers known under the trade designations PICCOTEX LC (a water-white thermoplastic resin produced by copolymerization of vinyltoluene and alpha-methylstyrene monomers having a ring and ball softening point of about 87°-95° C., available from Hercules Incorporated, Wilmington, Del.) and WINGTACK 10 (a liquid aliphatic C-5 petroleum hydrocarbon resin available from Goodyear Chemical) and an organic solvent such as toluene. An example of a tackified thermoplastic elastomer useful as an aggressively PSA is the combination of the styrene-poly(ethylene-butylene)-styrene block copolymer known under the trade designation KRATON G1657 (available from of Shell Chemicals) with one or more of the low molecular weight hydrocarbon resins known under the trade designation REGALREZ (from Hercules) and an organic solvent such as toluene. Both of these formulations may be coated using a knife coater and air-dried, or air-dried followed by oven drying. Of course, the invention is not limited to use of these specific combinations of thermoplastic resins, thermoplastic elastomers, and tackifiers.

Some presently preferred PSAs exhibit extended shelf life and resistance to detackifying under atmospheric conditions, and include acrylic-based copolymer adhesives as disclosed in U.S. Pat. No. Re 24,906. One example of such an acrylic-based copolymer is a 95.5:4.5 (measured in parts by weight of each) isooctylacrylate/acrylic acid copolymer. Another preferred adhesive is the copolymer of a 90:10 weight ratio combination of these two monomers. Yet other preferred adhesives are terpolymers of ethyl acrylate, butyl acrylate, and acrylic acid; copolymers of isooctylacrylate and acrylamide; and terpolymers of isooctylacrylate, vinyl-acetate, and acrylic acid.

Acrylic-based PSAs can be coated out of a coatable composition comprising an organic solvent, such as a heptane:isopropanol solvent mixture, and the solvent subsequently evaporated, leaving a pressure-sensitive adhesive coating. This layer is preferably from about 0.038 centimeters (cm) to about 0.11 cm (5 to 15 mils) thick when the substrate is a retroreflective sheeting material.

PSAs useful in the invention also may be characterized by having “180° peel adhesion” ranging from about 10 to about 1000 g/cm, more preferably at least about 50 g/cm. For aggressive PSAs the 180° peel adhesion typically ranges from about 200 g/cm to about 600 g/cm, measured using a standard test procedure. In this procedure, the force necessary to remove (i.e. peel) a PSA-coated substrate from a test substrate when the PSA-coated substrate is peeled from the test substrate is termed the “peel adhesion” value. A standard glass plate is cleaned using a solvent (such as one wash of diacetone alcohol followed by three washes of n-heptane). With very light tension, a sample having a PSA-backsize coating is then applied along the center of the standard glass plate, PSA side down. The sample is then rolled once with a 2.04 Kg hand roller. The standard glass plate is then secured to a horizontal platen in a standard peel adhesion tester such as that known under the trade name “IMASS.” One end of the sample is then attached to a hook that is a part of the peel adhesion tester. The sample is peeled from the standard glass plate at a 180° angle (i.e., one end of the sample is pulled toward the other end) by moving the platen horizontally at a speed of 228.6 cm/min, and the force required recorded, in g/cm of sample width, for various dwell times.

The sticker may optionally yet preferably comprise one or more tamper indicating features as are known in the art. Representative adhesion failure tamper indicating features are described in U.S. Pat. No. 5,153,042 (Indrelie); U.S. Pat. No. 5,770,283 (Gosselin et al.); and U.S. Pat. No. 4,999,076 (Faykish). Suitable delaminating film tamper indicating features are described in U.S. Pat. No. 4,876,123 (Rivera et al.); U.S. Pat. No. 6,395,376 (Cooley) and U.S. Pat. No. 6,416,857 (Wright). An exemplary tamper indicating film is commercially available from 3M under the trade designation “3M 7380 Tamper Indicating Film”.

Alternatively or in addition to the tamper indicating feature(s), the sticker may comprise one or more security features. Various security marking are known in the art such as (e.g. encrypted) bar code(s), dot codes, color-shifting marks, watermarks, holographic marks, marks visible in ultraviolet (UV) or infrared (1R) light, marks that include specular reflection shifts, such as metallic gold, silver or pearlescent marks, and marks of specific colors, many of which may be visibility shifting (i.e., visible at certain viewing angles and invisible at other viewing angles).

The present invention is particularly useful for validation sticker forms. Validation stickers are used as proof of registration of automobiles and other motor vehicles such as all-terrain vehicles, watercraft (e.g. boats), trucks, and snowmobiles. Other form constructions that are not necessarily retroreflective may also be produced such as fishing and hunting licenses, indoor/outdoor labeling products, product authentication articles, inventory labeling and control articles, window stickers and inspection stickers for automobiles and other equipment, parking permits, expiration stickers, park passes, advertisement mailers, decorative stickers etc.

The sticker substrate 26 typically comprises retroreflective sheeting that is often commercially available with pre-applied PSA layer 24 covered with a release liner. The two most common types of retroreflective sheeting suitable for use are microsphere-based sheeting and cube corner-based sheeting. Microsphere-based sheeting, sometimes referred to as “beaded sheeting,” is well known to the art and includes a multitude of microspheres typically at least partially embedded in a binder layer, and associated specular or diffuse reflecting materials (such as metallic vapor or sputter coatings, metal flakes, or pigment particles). Illustrative examples of microsphere-based sheeting are disclosed in U.S. Pat. No. 4,025,159 (McGrath); U.S. Pat. No. 4,983,436 (Bailey); U.S. Pat. No. 5,064,272 (Bailey); U.S. Pat. No. 5,066,098 (Kult); U.S. Pat. No. 5,069,964 (Tolliver); and U.S. Pat. No. 5,262,225 (Wilson).

Cube corner sheeting, sometimes referred to as prismatic, microprismatic, or triple mirror reflector sheetings, typically includes a multitude of cube corner elements to retroreflect incident light. Cube corner retroreflectors typically include a sheet having a generally planar front surface and an array of cube corner elements protruding from the back surface. Cube corner reflecting elements include generally trihedral structures that have three approximately mutually perpendicular lateral faces meeting in a single corner a cube corner. In use, the retroreflector is arranged with the front surface disposed generally toward the anticipated location of intended observers and the light source. Light incident on the front surface enters the sheet and passes through the body of the sheet to be reflected by each of the three faces of the elements, so as to exit the front surface in a direction substantially toward the light source. In the case of total internal reflection, the air interface must remain free of dirt, water and adhesive and therefore is enclosed by a sealing film. The light rays are typically reflected at the lateral faces due to total internal reflection, or by reflective coatings, as previously described, on the backside of the lateral faces. Preferred polymers for cube corner sheeting include poly(carbonate), poly(methylmethacrylate), poly(ethyleneterephthalate), aliphatic polyurethanes, as well as ethylene copolymers and ionomers thereof. Cube corner sheeting may be prepared by casting directly onto a film, such as described in U.S. Pat. No. 5,691,846 (Benson). Preferred polymers for radiation cured cube corners include cross linked acrylates such as multifunctional acrylates or epoxies and acrylated urethanes blended with mono-and multifunctional monomers. Further, cube corners such as those previously described may be cast on to plasticized polyvinyl chloride film for more flexible cast cube corner sheeting. These polymers are preferred for one or more reasons including thermal stability, environmental stability, clarity, excellent release from the tooling or mold, and capability of receiving a reflective coating.

In embodiments wherein the sheeting is likely to be exposed to moisture, the cube corner retroreflective elements are preferably covered with a seal film. In instances wherein cube corner sheeting is employed as the retroreflective layer, a backing layer may be present for the purpose of opacifying the laminate or article, improving the scratch and gouge resistance thereof, and/or eliminating the blocking tendencies of the seal film. Illustrative examples of cube corner-based retroreflective sheeting are disclosed in U.S. Pat. No. 5,138,488 (Szczech); U.S. Pat. No. 5,387,458 (Pavelka); U.S. Pat. No. 5,450,235 (Smith); U.S. Pat. No. 5,605,761 (Burns); U.S. Pat. No. 5,614,286 (Bacon) and U.S. Pat. No. 5,691,846 (Benson, Jr.).

The coefficient of retroreflection of the retroreflective stickers varies depending on the intended use. In general, however, the unprinted area of a uncolored (i.e. white or silver) retroreflective sticker typically has a coefficient of retroreflection ranging from about 5 to about 1500 candelas per lux per square meter at 0.2 degree observation angle and −4 degree entrance angle, as measured according to ASTM E-810 test method for coefficient retroreflection of retroreflective sheeting. The coefficient of retroreflection is preferably at least 10, more preferably at least 20, and even more preferably at least 50 candelas per lux per square meter. It is understood by those skilled in the art that the coefficient of retroreflection is lower for colored sheeting due to absorption and scattering.

Objects and advantages of the invention are further illustrated by the following examples, but the particular materials and amounts thereof recited in the examples, as well as other conditions and details, should not be construed to unduly limit the invention.

### EXAMPLE 1

### Tri-fold Self-seal Mailer with Release Coating and Sticker

A blank tri-fold self-seal mailer was obtained from Relizon Corp. (Dayton, Ohio). Adhesive was present on the longitudinal peripheral edges as well as the peripheral edge of the top third (i.e. first panel) of the form as well as on the backside of the mailer on the lower third (i.e. third panel) of the form at the peripheral edge along the fold line as well as on both longitudinal edges, as depicted in FIGS. 1a and 1b. The middle third (i.e. second panel was coated in the center portion with the solvent based release coating described in Example 2 of U.S. Pat. No. 6,497,787, using one pass of a hand held coater manufactured by Pamarco Inc. that employs a 150 line anilox roll. The release coating was dried in an oven at 100° F. for 5 minutes to evaporate the solvent. The release liner was removed from a license plate validation sticker commercially available from 3M under the trade designation “3M Validation Stickers on a Roll” in order the expose the underlying pressure sensitive adhesive. The exposed pressure sensitive adhesive surface layer of the sticker was contacted by hand to the dried release coating surface portion. The form construction having the sticker was printed with a laser printer commercially available from Hewlett Packard, Palo Alto, Calif. under the trade designation “HP LaserJet 2200 dn”. The resulting form construction is depicted in FIGS. 1a and 1b. After the mailer was printed, the mailer form may be folded and the peripheral edges of the mailer bonded together under pressure. The mailer may subsequently be opened at a later time and the sticker releasably removed from the release coating surface.

### EXAMPLE 2

### Tri-fold Self-seal Mailer with Release Coating and Sticker

Example 2 was prepared in the same manner as Example 1 with the exception that a 15% solids water-based release coating was used in place of the solvent-based release coating. The water-based release coating is the same base composition as the solvent based except that it was coated out of water instead of solvent. The same coating procedure was used as described in Example 1 except that two passes were used to provide better release of the sticker from the, paper form substrate.

### EXAMPLE 3

### Bi-fold Self-seal Mailer with Release Coating and Sticker

Example 3 was prepared in the same manner as Example 1 with the exception a bi-fold self-seal mailer commercially available from Relizon Corp. was employed. A waffle type security pattern was present on the form to hinder non-recipients from inadvertently reading the contents of the form. The resulting form construction is depicted in FIGS. 3a and 3b. After the mailer has been printed, the mailer form may be folded and the peripheral edges of the mailer bonded together under pressure. The mailer may subsequently be opened at a later time and the sticker releasably removed from the release coating surface.

### EXAMPLE 4

### Z-Fold Self-Seal Mailer with Release Coating and Sticker

Example 4 was prepared in the same manner as Example 1 with the exception a Z-fold self-seal mailer (as depicted in FIGS. 4a and 4b) commercially available from Relizon Corp.

### EXAMPLE 5

### Z-Fold Self-Seal Mailer with Release Coating and Sticker

Another Z-fold sample was made in a similar fashion to Example 4 with the exception that a ultraviolet (“UV”) curable prime coat was coated with a single pass using the Pamarco Inc. hand coater prior to applying the water based release coating described in Example 2. A suitable prime coat is commercially available from Akzo-Noble Inks under the trade designation “Flexocure”. The prime coat provides a barrier coat to help reduce the water absorption into the paper stock from the water based release coating and in turn help reduce paper wrinkling. The prime coat was cured in the UV curing unit manufactured by American Ultraviolet Co. using only one lamp to provide 250 milliJoules of energy with a web speed at 41 feet per minute. The water based release coating was then applied using a single pass with the hand coater and dried for 5 minutes at 100° F. The sticker was then releasably attached to the dried release coating.

1. A mailer comprising a form substrate having a digital printable surface portion, a release coating disposed on the form, and an adhesive disposed on the form such that the form may be folded and self-sealed.

2. The mailer of claim 1 further comprising a sticker comprising a backing and a pressure sensitive adhesive releasably attached to the release coating.

3. The mailer of claim 2 wherein the backing comprises a polymeric film.

4. The mailer of claim 2 wherein the backing is retroreflective.

5. The mailer of claim 2 wherein the sticker is selected from the group comprising a vehicle registration sticker, validation sticker, parking permit sticker, and park permit sticker.

6. The mailer of claim 2 wherein the sticker further comprises at least one tamper indicating feature.

7. The mailer of claim 1 wherein the form substrate is a roll-good.

8. The mailer of claim 7 wherein the substrate comprises perforations such that the form can be separated into individual sheets.

9. The mailer of claim 1 wherein the substrate is a sheet.

10. A mailer comprising a form having a digital printable surface portion, a digital printable release coating, and an adhesive disposed on the form such that the form may be folded and self-sealed.

11. The mailer of claim 10 further comprising a sticker comprising a backing and a pressure sensitive adhesive releasably attached to the release coating.

12. The mailer of claim 10 wherein the release coating comprises indicia.

13. The mailer of claim 10 wherein the release coating is digital printable by at least one of laser, ink-jet, thermal mass transfer, thermal dye transfer, electrostatic, ion deposition, electron beam imaging, solid ink-jet and dot-matrix printing.

14. The mailer of claim 10 wherein the sticker is digital printable by at least one of laser, ink-jet, thermal mass transfer, thermal, dye transfer, electrostatic, ion deposition, electron beam imaging, solid ink-jet and dot-matrix printing.

15. A method of making a self-seal mailer comprising:
providing a form comprising an adhesive suitable for self-sealing the form;
applying a release coating to at least a portion of the form;
providing a sticker comprising a backing and a pressure sensitive adhesive; and
releasably attaching the pressure sensitive adhesive of the sticker to the release coating.

16. A method of making a self-seal mailer comprising:
providing a form substrate;
applying a release coating to at least a portion of the form substrate;
providing a sticker comprising a backing and a pressure sensitive adhesive;
releasably attaching the pressure sensitive adhesive of the sticker to the release coating; and
applying an adhesive to at least a portion of the form wherein the adhesive is suitable for self-sealing the form substrate.

17. The method of claim 16 wherein the adhesive is applied to the form before releasably attaching the sticker.
